(19) United States
(12) Patent Application Publication
(10) Pub. No.: US 2006/0215821 A1
(43) Pub. Date: Sep. 28, 2006

(54) Voice nametag audio feedback for dialing a telephone call

(76) Inventors: Daniel S. Rokusek, Long Grove, IL (US); Kranti K. Kambhampati, Palatine, IL (US); Bogdan R. Nedelcu, North Barrington, IL (US); Edward Srenger, Schaumburg, IL (US)

Correspondence Address: MOTOROLA, INC., 1303 EAST ALGONQUIN ROAD, IL01/3RD, SCHAUMBURG, IL, 60196, US

(21) Appl. No.: 11/087,474

(22) Filed: Mar. 23, 2005

(51) Int. Cl. H04M 1/64

(52) U.S. Cl. 379/88.01

(57) ABSTRACT

A method and apparatus for assisting a user in the dialing of a telephone call using voice nametags. A first step includes inputting a telephone number with text. The next steps automatically create a voice nametag from the text for each telephone number using grapheme-to-phoneme conversion. Upon initiation of dialing, a next step enters a spoken phrase, which is then compared to the stored voice nametags. A next step determines a confidence level score of a match between the spoken phrase data and the representations of the stored voice nametags against at least one threshold. A next step selects the stored voice nametag with the best match to the spoken phrase data. A next step provides feedback to the user dependent upon the confidence level of the match, which can include automatically dialing the call if the confidence level is high enough. As part of this last step, an audio feedback tag is generated and stored based on the recognition result passing a confidence threshold criterion. Further steps are provided for improving the audio quality of the stored nametag based on signal to noise ratio.

### FIELD OF THE INVENTION

This invention relates generally to speech recognition systems, and more particularly to a system and method for assisting in dialing a communication device.

### BACKGROUND OF THE INVENTION

Recently, wireless communication systems, such as cellular telephones for example, have included speech recognition systems to enable a user to enter a sequence of digits of a particular number upon vocal pronunciation of a digit or digits. Further, a user can direct the telephone to dial an entire telephone number upon recognition of a simple voice command, i.e. voice activated dialing. For example, a user can have the telephone automatically dial a particular party upon a vocal input of that party's name or other command.

In order to effectuate the recognition of a vocal input, cellular telephones today require the user enroll the desired vocabulary words in order to be able to recognize the vocal input. This is accomplished by speaking the command to the phone and having the phone store a voice nametag prototype in memory along with the associated telephone number for future comparison. During this enrollment process, the system also records the actual audio input corresponding to the user utterance and associates it with the voice nametag and phone number for future playback when confirming a user input. Afterwards, when the user wishes to call that party, the user speaks out the nametag for the party, the telephone compares that spoken input against the prototypes stored in the memory, and if a suitable match is found, the telephone dials the associated telephone number. The system then plays back the audio sample associated with the voice nametag and phone number to confirm to the user the number being dialed.

A problem arises in a vehicle where it may not be convenient or safe for a driver to take the time to train a voice recognition system. Today's portable cellular phones can have over two hundred fifty or more phonebook entries, making training a long and cumbersome process.

Telematics and handsfree systems increasingly support the ability to download a phonebook from a portable cellular device to the vehicle communication system. Therefore, one solution to the problem is to use a vehicle's enhanced dialing facilities (e.g. voice dialing, stalk-mounted controls, radio/head units) to place calls from this downloaded phonebook. However, the problem of command enrollment in the portable telephone to store the phonebook still persists.

Another solution is to use a speech recognition system, which now has the ability to automatically create voice nametags from text (i.e. using a text-to-speech engine). This enables a voice nametag to be created automatically for each phonebook entry that has text associated with it. However, if this system is used, either a text-to-speech engine is required (at a large memory and processing cost) or the user would need to revert to recording voice tags for all entries initially and after each change to the phonebook, which would be frustrating and time consuming.

What is needed is a voice nametag system that reduces that amount of required user interaction, and avoids the cost associated with using a text-to-speech engine. It would also be of benefit to automatically create voice nametags from text and provide an audio confirmation to the user for each nametag in the phonebook without a text-to-speech engine. In addition, it would be of benefit to provide these advantages without any additional hardware cost.

### BRIEF DESCRIPTION OF THE DRAWINGS

The features of the present invention, which are believed to be novel, are set forth with particularity in the appended claims. The invention, together with further objects and advantages thereof, may best be understood by making reference to the following description, taken in conjunction with the accompanying drawings, in the several figures of which like reference numerals identify identical elements, wherein:

FIG. 1 shows a simplified block diagram for an apparatus, in accordance with the present invention; and

FIG. 2 shows a simplified block diagram of a method, in accordance with the present invention.

### DETAILED DESCRIPTION OF THE PREFERRED EMBODIMENT

The present invention provides an apparatus and method for a voice nametag system that automatically creates an audio confirmation capability during normal use of the system without additional user intervention. It avoids the cost of using a text-to-speech engine by using an algorithm based upon recording live speech during normal use of the system in conjunction with the ability to automatically create voice nametags from text. In addition, these advantages are provided without any additional hardware cost.

The concept of the present invention can be advantageously used on any electronic product interacting with audio, voice, and text signals. Preferably, the radiotelephone portion of the communication device is a cellular radiotelephone adapted for mobile communication, but may also be a pager, personal digital assistant, computer, cordless radiotelephone, or a portable cellular radiotelephone. The radiotelephone portion generally includes an existing microphone, speaker, controller and memory that can be utilized in the implementation of the present invention. The electronics incorporated into a mobile cellular phone, are well known in the art, and can be incorporated into the communication device of the present invention.

Many types of digital radio communication devices can use the present invention to advantage. By way of example only, the communication device is embodied in a mobile cellular phone, such as a Telematics unit, having a conventional cellular radiotelephone circuitry, as is known in the art, and will not be presented here for simplicity. The mobile telephone, includes conventional cellular phone hardware (also not represented for simplicity) such as processors and user interfaces that are integrated into the vehicle, and further includes memory, analog-to-digital converters and digital signal processors that can be utilized in the present invention. Each particular wireless device will offer opportunities for implementing this concept and the means selected for each application. It is envisioned that the present invention is best utilized in a vehicle with an automotive Telematics radio communication device, as is presented below, but it should be recognized that the present invention is equally applicable to home computers, portable communication devices, control devices or other devices that have a user interface that could be adapted for voice operation.

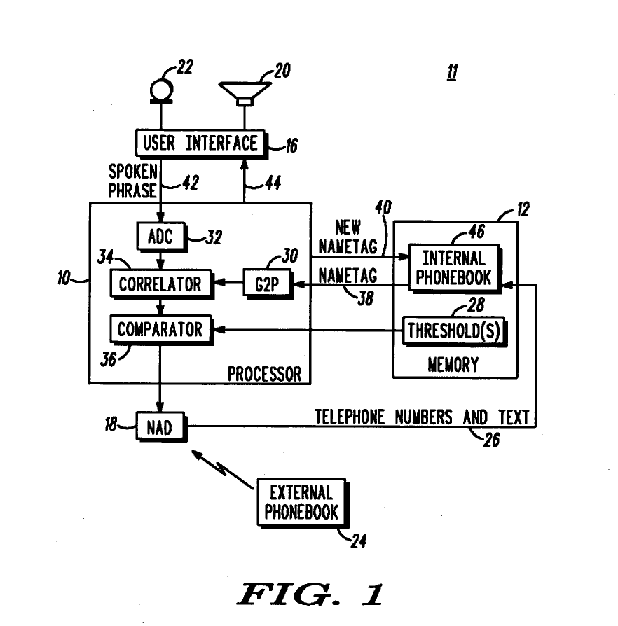

FIG. 1 shows a simplified representation of a communication device 11 having dialing assistance using voice nametags, in accordance with the present invention. The communication device can be a Telematics device installed in a vehicle, for example. A processor 10 is coupled with a memory 12. The memory can be incorporated within the processor or can be a separate device as shown. The processor can include a microprocessor, digital signal processor, microcontroller and the like. The processor is also coupled with a transceiver, such as network access device 18 (NAD), which is used to connect to a wireless radio telephone network, as are known in the art. An existing user interface 16 of the vehicle is also coupled to the processor 10 and can include a microphone 22 and loudspeaker 20.

An external phonebook 24 contains a listing of telephone numbers with associated text, such a user's phonebook information/data that can be contained in a user's portable cellular telephone, personal digital assistant, computer, or any other communication device. The phonebook 24 including telephone numbers and text can be downloaded to the internal phonebook 46 in the memory 12 of the device 11, using any of the available synchronization protocols known in the art. Typically, the download is performed wirelessly through a wide area network or local area network using techniques known in the art, or can be done using a wired link. Alternatively, the phonebook information can be present on the device with an original phonebook, with no downloading necessary).

The phonebook typically contains text entries such as “Home” that are associated with a telephone number, such as “234-555-6789” indicating the user's home. The present invention automatically creates an audio feedback tag for the corresponding text entry in the phonebook 46 without any user action. When the system is used to phone dial “234-555-6789,” the system should give the user feedback that “Home” is being called or query them if they want to call “Home.”

The processor 10 includes a grapheme-to-phoneme (G2P) converter 30 as is known in the art. The processor can use a dictionary of phonemes that are provided for a particular language to enable the G2P engine to convert text 38 from the internal phonebook 46 into a representation of a voice nametag. This is done for all the text entries in the phonebook 46. The present invention does not require a user to manually provide voice samples for each phonebook entry, and instead automatically creates an audio feedback tag to store along with a phonemic representation of a voice nametag from the text associated with each telephone number. Specifically, the invention creates an audio feedback tag as the user is interacting with the system (based on confidence scores, thresholds, etc).

Upon initiation of a dialing sequence a user can speak a command, such as “Call Home” into the microphone 22 of the device 11. The microphone transduces the audio signal into an electrical signal. The user interface passes this signal 42 to the processor 10, and particularly an analog-to-digital converter 32, which converts the audio signal to a digital signal that can be used by the processor. Further processing can be done on the signal by (digital signal) processing to extract relevant speech features of the spoken phrase 42. A correlator 34, or Viterbi type decoder, compares the spoken phrase data to the phoneme-based representations of the list of stored voice nametags that are generated from the internal phonebook 46 by the G2P engine 30.

For example, the correlator 34 can take the feature set representation of the spoken phrase and compare it to the set of voice nametag representations. The feature representation can be for instance a set of cepstral vectors, as is known in the art. A confidence level score is determined based on the scores generated between the spoken phrase and each voice nametag from the phonebook list. Specifically, the confidence level scores are determined from the Viterbi decoder path scores. The correlator 34 then outputs these confidence level scores to a comparator 36.

A comparator 36 sorts the calculated scores to find the match with the highest confidence level (i.e. best match). Next, checking against a confidence threshold is necessary for determining the audio feedback strategy that is to be implemented to provide information to the user as to the nametag that has been selected for dialing. The comparator 36 tests the best match against at least one predetermined threshold. For example, if the confidence level of the match between the representations of the spoken phrase and voice nametag is greater than or equal to an acceptance threshold, then the match is deemed correct, the user can be provided with an audio feedback tag confirmation of the associated voice nametag, and the telephone number corresponding to that voice nametag in the phonebook can be dialed and the call placed automatically. However, if the confidence level of the match between the representations of the spoken phrase and voice nametag is less than a predefined acceptance threshold, then the match is deemed incorrect, and feedback can be provided to the user to try to improve the confidence level by repeating the spoken phrase. If the confidence level falls between acceptance and minimum thresholds, the user can be provided with a list of alternate matches that should contain the correct voice nametag, such as by playing a list of audio feedback tags associated with the best-matched (in terms of confidence scores) phonebook entries. The threshold(s) can be variable in response to external effects such as ambient noise conditions, for example. Choosing the actual threshold value is dependent on the acceptable level of false rejects and false accepts, as will be explained below.

From a statistical point of view, two significant types of errors can occur from voice recognition method; a high confidence score to an incorrect phrase or false accept, and the rejection (low confidence score) of a correct phrase, or false reject. In the former case, the voice recognition system determines that a phrase is valid when it is not. In the latter case, the voice recognition system determines that a phrase is invalid when it is should have been accepted as valid. By choosing the threshold values properly, a successful tradeoff can be made wherein the present invention provides proper confidence levels to correctly identify matches.

The feedback to the user can take several forms. Preferably, an audio query 44 can be directed to the user interface 16 through an existing loudspeaker 20. The query can take the form of a request to confirm the voice nametag, or associated telephone number of the best match, or in the case of very poor confidence levels the user may be requested to: re-enter the spoken phrase, select an entry upon hearing the playback of the list of voice nametags (based on availability of audio feedback tags), or telephone numbers.

Therefore, it is preferred that two confidence level thresholds be used. Above the upper, or acceptance threshold the call is placed automatically. An audio feedback corresponding to the utterance the user just spoke can be provided as confirmation as to the associated phonebook entry that will be dialed. If no previous audio feedback is associated with the phonebook entry, an audio tag corresponding to the user's utterance is stored in memory and associated with the phonebook entry for future use as well as the signal to noise ratio (SNR) of the audio feedback tag. In the case where there is already an audio feedback tag available for the corresponding phonebook entry, this audio feedback tag is played back to the user as confirmation. The system compares the current audio feedback tag's SNR to the one stored in memory. If the SNR level of the current speaker utterance is higher than the audio feedback tag in memory, the audio tag corresponding to the phonebook entry is updated with the latest voice sample of the user. This ensures that the audio quality of the audio feedback tag is constantly monitored to provide the best user experience. Optionally, a phonemic representation of the spoken utterance generated with an acoustic-to-phonetic engine can supplement existing G2P generated nametag pronunciations for future calls, since the spoken phrase will often be a much better match to future user inputs than G2P generated representations.

When the confidence threshold falls between an upper (acceptance) and lower (minimum) threshold there is likelihood that the highest score voice nametag may be incorrect, and the user is prompted to confirm the selected best entry before the call is placed. If an audio feedback tag already exists for the highest score phonebook entry, the audio tag is played back and the user asked for confirmation prior to dialing. Similarly, if an N-best candidate list (where N is the number of returned recognition results) is used, and all the voicetags have corresponding audio feedback tags, the user will be able to select the correct entry in the list upon hearing the correct audio feedback tag. If an audio feedback tag does not yet exist the user is asked to repeat the utterance. Below the lower minimum threshold, it is clear that there is no valid match, and the user is automatically requested to repeat the utterance in order to perform another recognition attempt. If this fails, further inquiries concerning all the stored phonebook entries are made.

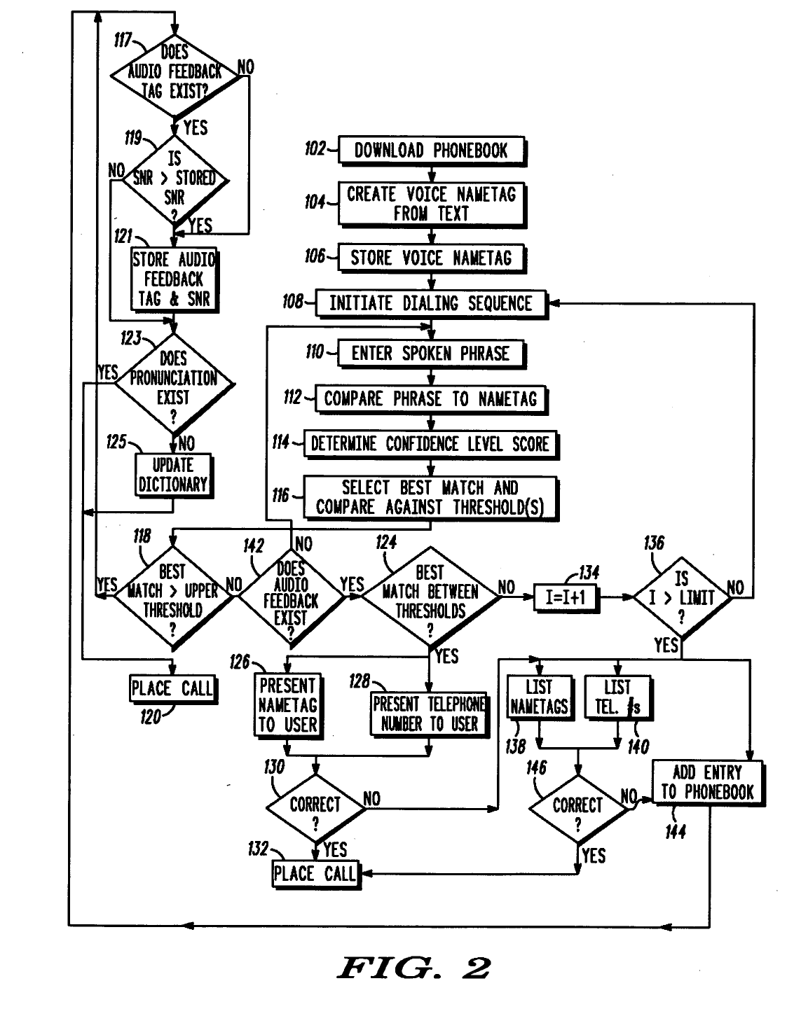

The present invention also includes a method for providing dialing audio feedback for a communication device using voice nametags, without the requirements of prior user enrollment or a text-to-speech component, in accordance with the present invention. Referring to FIG. 2, the method comprises a first step 102 of inputting at least one telephone number with associated text into a communication device. Typically, a plurality of telephone numbers and associated text are downloaded to a phonebook of the device, as described above. The phonebook typically contains text entries such as “Home” that are associated with a telephone number, such as “234-555-6789” indicating the user's home number.

A next step 104 includes automatically creating representations of the voice nametags from the text associated with each telephone number in the phonebook list by using a grapheme-to-phoneme algorithm to convert the text to the phonemic representation of the voice nametag. The phoneme-based representation of the voice nametags can be buffered or stored 106 in the communication device.

A next step 108 includes initiating a dialing sequence, which includes several substeps. One substep 110 includes entering data representing a spoken phrase into the communication device. For example, upon initiation of a dialing sequence a user can speak a command, such as “Call Home” into the device. Processing can be done on the signal to extract relevant speech features that represent the spoken phrase.

A next substep 112 includes correlating or comparing the spoken phrase representation to the phoneme representations of the list of stored voice nametags that are created from the text of the phonebook. A next substep 114 includes determining a confidence level score between the spoken phrase data and the representations of the stored voice nametags, as described above. A confidence level score is determined between the spoken phrase and each voice nametag from the phonebook list.

A next substep 116 includes sorting and selecting the representation of the stored voice nametag with the best match to the spoken phrase data and comparing the confidence score of the best match against at least one threshold, and preferably an upper and a lower threshold. For example, if the confidence level score of the best match between the representations of the spoken phrase and voice nametag is greater than or equal to the upper threshold 118, then the match is deemed correct, and the telephone number corresponding to that voice nametag in the phonebook can be dialed and the call placed 120 automatically. If the phonebook entry has an associated audio feedback tag, confirmation should be provided to the user utilizing this recorded audio feedback tag. Otherwise, an audio feedback tag is generated from the phrase uttered by the user. If an audio feedback tag already exists 117, a signal-to-noise ratio (SNR) check is performed 119 between the stored audio feedback tag and the new utterance. The stored audio feedback tag is replaced by the new utterance if the SNR of the stored voice nametag is less than the SNR of the new utterance. In addition, if a user-specific pronunciation of the voice nametag does not exist 123, then a phonemic representation of the spoken phrase can be used to update 125 a pronunciation dictionary of the voice nametag for future calls, since the spoken phrase often will be a much better match to future user inputs.

If the confidence level of the match between the representations of the spoken phrase and voice nametag is less than the upper threshold 118, then further checking is required, dependent upon the confidence level of the above selected representation of the voice nametag. The feedback can take various forms. In this particular case, if no audio feedback tag was previously stored 142 the user would be prompted to repeat the utterance.

If the confidence level is between the lower and upper threshold 124, the method will present the user with the representation of the voice nametag having the best match to the spoken phrase data 126, and provided there is already an audio feedback tag associated with this best match, a query 130 will be presented to the user as to whether this is the nametag to dial. Alternatively, the method can present the user with the telephone number associated with the voice nametag having the best match to the spoken phrase data 128 and querying 130 the user as to whether this is the proper telephone number to dial. If the user indicates that either the voice nametag or telephone number is correct 130 then the call can be placed 132. If the user indicates that neither the voice nametag nor telephone number are correct 130 then further feedback is needed, as in the same case where the confidence level of the best match is below the lower threshold.

If the confidence level is below the lower threshold, a counter is incremented 134 and checked against a limit 136 to allow the method to repeat the initiating step 108 a certain number of times to try to improve the confidence level of comparison to the spoken phrase by requesting the user to provide another sample of the spoken phrase. If such repetition is unfruitful (i.e. the counter goes over the repetition limit 136, then further feedback is needed. Such feedback can take the form of: playing back the list of all voice nametags 138 with associated audio feedback tags in the phonebook seeking to find a match, playing back the list of all telephone numbers 140 in the phonebook seeking to find a match, wherein the user is queried 146 as to whether any particular nametag or telephone number in the phonebook is the correct number to dial 132. Other feedback can be provided when no entry for the user's spoken utterance exists, by asking the user to add a telephone number to associate and store with the representation of the spoken phrase 144. Upon completion of the storing of the telephone number, text entry, generation of the G2P representation, and storing of the audio feedback tag a call 120 can be placed.

In review, the present invention provides an apparatus and method that assists a user in the dialing of a telephone call using voice nametags, which are automatically created, thereby eliminating the cumbersome need to manually enter voice recording for each phonebook entry. The invention automatically stores audio feedback tags, associated with the corresponding phonemic representation of the voice nametags, for future playback. Initial storage decision of the audio feedback tag is provided through a confidence threshold methodology and existing audio feedback tags are updated based on measured signal to noise ratio (SNR). The invention provides further improvement by augmenting existing G2P engine generated voice nametags representations with a user specific sample of a voice nametag that have been selected by passing the highest confidence threshold criterion, wherein the user automatically improves the system as it is used, without any further effort.

While the present invention has been particularly shown and described with reference to particular embodiments thereof, it will be understood by those skilled in the art that various changes may be made and equivalents substituted for elements thereof without departing from the broad scope of the invention. In addition, many modifications may be made to adapt a particular situation or material to the teachings of the invention without departing from the essential scope thereof. Therefore, it is intended that the invention not be limited to the particular embodiments disclosed herein, but that the invention will include all embodiments falling within the scope of the appended claims.

What is claimed is:

1. A method for assisting a user in the dialing of a telephone call using voice nametags and audio feedback, the method comprising the steps of:
inputting at least one telephone number with associated text into a communication device;
automatically creating a representation of a voice nametag from the text associated with each telephone number; and
initiating a dialing sequence including the substeps of:
entering data representing a spoken phrase into the communication device,
comparing the spoken phrase data to the representations of the stored voice nametags,
determining a confidence level score of a match between the spoken phrase data and the representations of the stored voice nametags,
selecting the representation of the stored voice nametag with the best score to the spoken phrase data and comparing the confidence level score of the best match against at least one predetermined threshold, and
providing audio feedback to the user dependent upon the confidence level of the above selected representation of the voice nametag and the at least one predetermined threshold.

2. The method of claim 1, further comprising the step of using the spoken phrase to automatically generate an audio feedback tag.

3. The method of claim 2, wherein the audio feedback tag is associated with a phonebook entry.

4. The method of claim 3, wherein the spoken phrase replaces an existing audio feedback tag if the signal-to-noise ratio of the spoken phrase is greater than a signal-to-noise ratio of the existing audio feedback tag.

5. The method of claim 1, further comprising the substep of storing a representation of the spoken phrase with the representation of the voice nametag depending upon the confidence level of the determining step.

6. The method of claim 1, wherein the determining substep includes an upper and a lower threshold level, and wherein providing feedback substep includes the substeps of:
if the confidence level is above the upper threshold, placing the call by dialing the telephone number associated with the best matched representation of voice nametag,
if the confidence level is between the lower and upper threshold, presenting the user with the representation of the voice nametag having the best match to the spoken phrase data and querying the user as to whether this is the nametag to dial, and
if the confidence level is below the lower threshold, repeating the initiating step.

7. The method of claim 1, wherein the determining substep includes an upper and a lower threshold level, and wherein providing feedback substep includes the substeps of:
if the confidence level is above the upper threshold, placing the call by dialing the telephone number associated with the best matched representation of voice nametag,
if the confidence level is between the lower and upper threshold, presenting the user with the telephone number associated with the voice nametag having the best match to the spoken phrase data and querying the user as to whether this is the proper telephone number to dial, and
if the confidence level is below the lower threshold, repeating the initiating step.

8. The method of claim 7, wherein if the repeating substep repeats a predetermined number of time, asking the user to add a telephone number to associate and store with the representation of the spoken phrase.

9. The method of claim 7, wherein if the repeating substep repeats a predetermined number of times, presenting the user with each of the stored voice nametags in turn, and querying the user as to whether this is the proper nametag to dial.

10. The method of claim 7, wherein if the repeating substep repeats a predetermined number of times, presenting the user with each telephone number associated with voice nametags in turn, and querying the user as to whether this is the proper telephone number to dial.

11. A method for assisting a user in the dialing of a telephone call using voice nametags and audio feedback, the method comprising the steps of:
inputting at least one telephone number with associated text into a communication device;
automatically creating representation of a voice nametag from the text associated with each telephone number by using a grapheme-to-phoneme algorithm to convert the text to the representation of the voice nametag;
storing the representation of the voice nametag in the communication device; and
initiating a dialing sequence including the substeps of:
entering data representing a spoken phrase into the communication device,
generating an audio feedback tag from the spoken phrase and associating the audio feedback tag with the telephone number;
comparing the spoken phrase data to the representations of the stored voice nametags,
determining a confidence level score of a match between the spoken phrase data and the representations of the stored voice nametags,
selecting the representation of the stored voice nametag with the best match to the spoken phrase data and comparing the confidence level score of the best match against an upper and a lower threshold, wherein
if the confidence level score is above the upper threshold, placing the call by dialing the telephone number associated with the best matched representation of voice nametag, and
if the confidence level score is below the upper threshold, providing audio feedback to the user dependent upon the confidence level of the above selected representation of the voice nametag.

12. The method of claim 11, wherein the providing feedback substep includes the substeps of:
if the confidence level score is between the lower and upper threshold, presenting the user with a plurality of representations of the voice nametags having associated audio feedback tags with the best matches to the spoken phrase data and querying the user as to whether this is the proper entry to dial, and
if the confidence level score is below the lower threshold, repeating the initiating step.

13. The method of claim 11, wherein the providing feedback substep includes replacing an existing audio feedback tag with the spoken phrase if the signal-to-noise ratio of the spoken phrase is greater than a signal-to-noise ratio of the existing audio feedback tag.

14. The method of claim 13, wherein if the repeating substep repeats a predetermined number of times, asking the user to add a telephone number to associate and store with the representation of the spoken phrase.

15. The method of claim 13, wherein if the confidence level is above the upper threshold, storing a representation of the spoken phrase in place of an existing audio feedback tag.

16. The method of claim 13, wherein if the repeating substep repeats a predetermined number of times, presenting the user with each of the phonebook entries in turn, and querying the user as to whether this is the proper entry to dial.

17. The method of claim 13, wherein if the repeating substep repeats a predetermined number of times, presenting the user with each telephone number associated with voice nametags in turn, and querying the user as to whether this is the proper telephone number to dial.

18. A communication device that assists a user in the dialing of a telephone call using voice nametags and audio feedback, the communication device comprising:
a phonebook in a memory that is loaded with a list of telephone numbers and associated text;
a user interface coupled to the processor, the user interface operable to enter a spoken phrase and provide audio feedback;
a processor coupled to the phonebook, the processor operable to create a representation of a voice nametag from the text associated with each telephone number and provide associated audio feedback; and
a correlator coupled with the processor, the correlator being operable to input a representation of the spoken phrase, correlate it against the representations of stored voice nametags in the phonebook to find the best match, and provide a confidence level for each comparison; and
a comparator coupled with the processor, the comparator operable to compare the confidence level of the best match against at least one predetermined threshold, wherein feedback is provided to the user dependent upon the confidence level of the best match.

19. The device of claim 18, wherein:
if the confidence level is above the upper threshold, the processor places the call by dialing the telephone number associated with the best matched representation of voice nametag and automatically stores the spoken phrase as an audio feedback tag associated with the telephone number, and
if the confidence level is below the threshold, the processor presents to the user on the user interface the telephone number associated with one or more voice nametags having an acceptable match to the spoken phrase data and queries the user as to whether this is the proper telephone number to dial.

20. The device of claim 18, wherein if the confidence level is between the lower and upper threshold, the processor replaces an existing audio feedback tag with the spoken phrase if the signal-to-noise ratio of the spoken phrase is greater than a signal-to-noise ratio of the existing audio feedback tag.
